(19) United States
(12) Patent Application Publication
(10) Pub. No.: US 2017/0155958 A1
(43) Pub. Date: Jun. 1, 2017

(54) Method, Apparatus and System for Playing Multimedia Data, and Storage Medium

(71) Applicant: XIAOMI INC., Beijing (CN)

(72) Inventors: Qiang FU, Beijing (CN); Ziguang GAO, Beijing (CN); Enxing HOU, Beijing (CN)

(73) Assignee: XIAOMI INC., Beijing (CN)

(21) Appl. No.: 15/347,554

(22) Filed: Nov. 9, 2016

(30) Foreign Application Priority Data
Nov. 30, 2015 (CN) 201510856759.4

(51) Int. Cl. H04N 21/45; H04L 29/06; H04N 21/84; H04N 21/41; H04N 21/436; H04L 29/08; H04N 21/472

(52) U.S. Cl. CPC H04N 21/4532; H04L 67/306; H04L 67/303; H04L 67/42; H04L 65/60; H04N 21/47217; H04N 21/4122; H04N 21/43615; H04N 21/47202; H04N 21/84

(57) ABSTRACT

A method, an apparatus, and a system are provided for playing multimedia data. In the method: a first terminal sends to a server a request for acquiring play record information. The server receives the request for acquiring play record information sent by the first terminal. The server acquires play record information of a second terminal bound to the first terminal. The server controls the first terminal to continue play of corresponding target multimedia data according to the play record information.

### CROSS-REFERENCE TO RELATED APPLICATION

The present application is based on and claims the priority to Chinese patent application No. 201510856759.4, filed on Nov. 30, 2015, which is incorporated by reference herein in its entirety.

### TECHNICAL FIELD

The present disclosure relates to the field of computer technologies, and more particularly, to methods, apparatus and systems for playing multimedia data, and a storage medium.

### BACKGROUND

With the development of computer technologies, there are an increasing number of and a greater variety of multimedia contents such as video data, audio data, and the multimedia contents, which can be played in an increasing number of forms. For example, terminals such as smart televisions and smart mobile phones can be used to play multimedia data.

Generally, if a user, who is watching certain multimedia data in a multimedia application on a smart device, desires to change the smart device and continue the watching, he or she may close the current smart device and then open a multimedia application on another smart device. At this time, the user needs to find the multimedia data in the multimedia application by searching and then find the play time progress on the play time axis of the multimedia data so as to watch the multimedia data.

The inventor of this disclosure found at least the following problem. When a user changes the smart device during the play of multimedia data, the user needs to find the multimedia data in the multimedia application by searching and then find the play time progress on the play time axis of the multimedia data to watch or listen to the multimedia data, which may lead to low efficiency in starting the play of the multimedia data.

### SUMMARY

According to a first aspect of embodiments of the disclosure, a method for playing multimedia data is provided. The method includes: receiving a request for acquiring play record information, the request being sent by a first terminal; acquiring play record information of a second terminal bound to the first terminal; controlling the first terminal to continue play of corresponding target multimedia data according to the play record information.

According to a second aspect of embodiments of the disclosure, a method for playing multimedia data is provided. The method includes: sending to a server a request for acquiring play record information; receiving play record information of a second terminal bound to the first terminal, which is sent by the server; and continuing play of corresponding target multimedia data according to the play record information.

According to a third aspect of embodiments of the disclosure, an apparatus for playing multimedia data is provided. The apparatus includes: a first receiving module for receiving a request for acquiring play record information, the request being sent by a first terminal; an acquiring module for acquiring play record information of a second terminal bound to the first terminal; a controlling module for controlling the first terminal to continue play of corresponding target multimedia data according to the play record information.

According to a fourth aspect of embodiments of the disclosure, an apparatus for playing multimedia data is provided. The apparatus includes: a sending module for sending to a server a request for acquiring play record information; a receiving module for receiving the play record information of a second terminal bound to the first terminal, which is sent by the server; a playing module for continuing play of corresponding target multimedia data according to the play record information.

According to a fifth aspect of embodiments of the disclosure, a system for playing multimedia data is provided. The system includes a server and a first terminal. The server is configured to: receive a request for acquiring play record information, the request being sent by the first terminal; acquire play record information of a second terminal bound to the first terminal; control the first terminal to continue play of corresponding target multimedia data according to the play record information. The first terminal is configured to: send to the server the request for acquiring play record information; receive the play record information of the second terminal bound to the first terminal, which is sent by the server; continue the play of the corresponding target multimedia data according to the play record information.

According to a sixth aspect of embodiments of the disclosure, there is provided a non-transitory computer-readable storage medium having stored therein instructions that, when executed by a processor of a mobile terminal, causes the mobile terminal to perform a method for playing multimedia data. The method includes following acts: receiving a request for acquiring play record information, the request being sent by a first terminal; acquiring play record information of a second terminal bound to the first terminal; and controlling the first terminal to continue play of corresponding target multimedia data according to the play record information.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure. In the drawings:

FIG. 1 is a flow chart of playing multimedia data illustrated according to an exemplary embodiment;

FIG. 2 is a flow chart of playing multimedia data illustrated according to an exemplary embodiment;

FIG. 3 is a flow chart of playing multimedia data illustrated according to an exemplary embodiment;

FIG. 4 is a schematic diagram illustrating an interface display of a terminal according to an exemplary embodiment;

FIG. 5 is a schematic diagram illustrating an interface display of a terminal according to an exemplary embodiment;

FIG. 6 is a schematic diagram illustrating an interface display of a terminal according to an exemplary embodiment;

FIG. 7 is a structure schematic diagram of an apparatus for playing multimedia data according to an exemplary embodiment;

FIG. 8 is a structure schematic diagram of an apparatus for playing multimedia data according to an exemplary embodiment;

FIG. 9 is a structure schematic diagram of an apparatus for playing multimedia data according to an exemplary embodiment;

FIG. 10 is a structure schematic diagram of an apparatus for playing multimedia data according to an exemplary embodiment;

FIG. 11 is a structure schematic diagram of an apparatus for playing multimedia data illustrated according to an exemplary embodiment;

FIG. 12 is a structure schematic diagram of an apparatus for playing multimedia data according to an exemplary embodiment;

FIG. 13 is a structure schematic diagram of a server according to an exemplary embodiment; and

FIG. 14 is a structure schematic diagram of a terminal according to an exemplary embodiment.

The above drawings illustrate specific embodiments of the disclosure which will be described in detail hereinafter. These drawings and description are not intended to limit the scope of the inventive concept in any way but to explain the concept of the disclosure to those skilled in the art by referring to the specific embodiments.

### DETAILED DESCRIPTION

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Reference will now be made in detail to certain embodiments, examples of which are illustrated in the accompanying drawings. The following description refers to the accompanying drawings in which the same numbers in different figures represent the same or similar elements unless otherwise indicated. The implementations set forth in the following description of embodiments do not represent all implementations consistent with the disclosure. Instead, they are merely examples of devices and methods consistent with aspects related to the disclosure as recited in the appended claims.

An embodiment of the disclosure provides a method for playing multimedia data. This method for playing multimedia data may be implemented by a server and a terminal collectively. The server may be a background server for a management application of a smart device, and the terminal may be a terminal having installed therein a multimedia application and a management application.

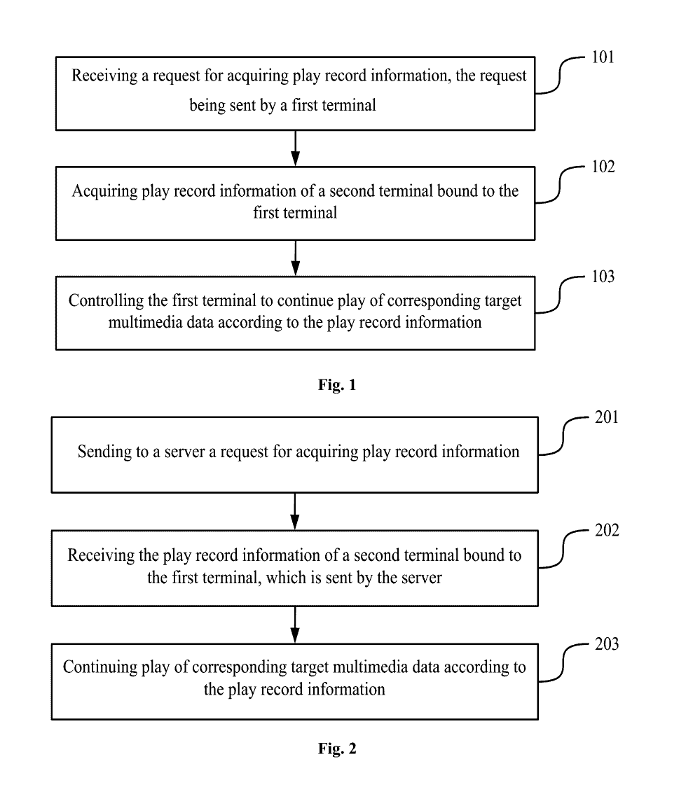

As shown in FIG. 1, the operational procedure of the server in the method may include the following steps.

In Step 101, a request for acquiring play record information is received, the request being sent by a first terminal.

In Step 102, play record information of a second terminal bound to the first terminal is acquired.

In Step 103, the first terminal is controlled to continue play of corresponding target multimedia data according to the play record information.

As shown in FIG. 2, the operational procedure of the terminal in the method may include the following steps.

In Step 201, a request for acquiring play record information is sent to a server.

In Step 202, play record information of a second terminal bound to the first terminal, which is sent by the server, is received.

In Step 203, play of corresponding target multimedia data is continued according to the play record information.

In the disclosure, a first terminal sends to a server a request for acquiring play record information; the server receives the request for acquiring play record information sent by the first terminal; the server acquires play record information of a second terminal bound to the first terminal; the server controls the first terminal to continue play of corresponding target multimedia data according to the play record information; the first terminal receives the play record information of the second terminal bound to the first terminal, which is sent by the server; and the first terminal continues the play of corresponding target multimedia data according to the play record information. Thereby, when a user changes the terminal during the play of multimedia data, the terminal used after the change may automatically acquire the play record information on the terminal used before the change, and then automatically play the multimedia data corresponding to the play record information. Accordingly, the user can watch the multimedia data be or she previously watched on the terminal used before the change without searching and finding, thereby improving the efficiency in starting the play of the multimedia data.

Another embodiment of the disclosure provides a method for playing multimedia data. This method for playing multimedia data may be implemented by a server and terminals (a first terminal and a second terminal) collectively. The server may be a background server for a management application of a smart device (e.g. a smart home application) and may include a processor, a memory, a transceiver, etc. The processor may process the multimedia data in the procedure of playing the multimedia data and process requests from the terminals, the memory may store data required or produced during the procedure of playing the multimedia data, and the transceiver may receive and transmit messages. The terminal may be a smart mobile phone, a tablet computer, a smart television, etc. The terminal may have installed therein a multimedia application and a management application for the smart device, and may be provided with a processor, a memory, a transceiver, etc. Similarly, the processor in the terminal may process multimedia data in the procedure of playing the multimedia data, the memory may store data required or produced during the procedure of playing the multimedia data, and the transceiver may receive and transmit messages. The terminal may also include an input/output device such as a screen, etc. The screen may be used to display a management application interface, a multimedia data play interface, etc. of the smart device. The screen may be a touch screen.

Here, the user may bind together a first terminal and a second terminal which are usually used to play multimedia data. For example, the user may install a management application for smart device in each of the first terminal and the second terminal, and then start the management application. The terminals may each display a login interface of the management application. The user may input an account identification and a password, and click a confirmation key to trigger the terminal to send to the server a terminal identification of the terminal. The server may store the correspondence between the terminal identification and the account identification. The user may input the same account identification and password in the management applications of both the first terminal and the second terminal. Thereby, in the correspondence stored in the server, this account identification may correspond to the first terminal and the second terminal so that the first terminal and the second terminal are bound together.

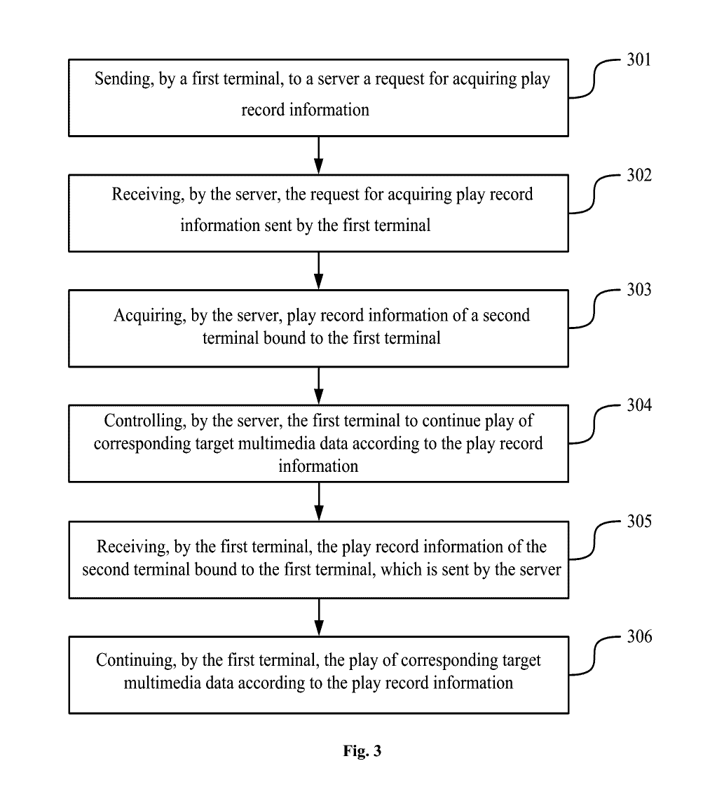

In the following, the operational procedure shown in FIG. 3 will be explained in detail in connection with implementations.

In Step 301, a first terminal sends to a server a request for acquiring play record information.

In an implementation, the user may close the multimedia application of the second terminal while using the multimedia application of the second terminal to watch a video, and the user may then open the multimedia application of the first terminal to watch the same multimedia data. At this time, the first terminal may send to the server a request for acquiring play record information, the request for acquiring play record information carrying the terminal identification of the first terminal. For example, the user watching multimedia data on a smart television in the parlour closes the smart television in the parlour, walks into the bedroom, and uses a mobile phone to watch the multimedia data. When the multimedia application on the mobile phone is started, the mobile phone may send to the server a request for acquiring play record information.

Alternatively or additionally, the request for acquiring play record information is sent to the server when a start of a multimedia application is detected.

For example, the user may close the multimedia application of the second terminal while using the multimedia application of the second terminal to watch multimedia data, and the user may then open the multimedia application of the first terminal to watch this multimedia data. At this time, the user may click an option on the multimedia application of the first terminal. The first terminal receives the click instruction and starts the multimedia application. When the management application detects the start of the multimedia application, it triggers the first terminal to send to the server a request for acquiring play record information, the request for acquiring play record information carrying the terminal identification of the first terminal. For example, the user watching a video on a smart television in the parlour closes the smart television in the parlour, walks into the bedroom, and uses a mobile phone to watch the video. When the multimedia application on the mobile phone is started, the management application detects the start of the multimedia application and triggers the mobile phone to send to the server a request for acquiring play record information.

In another example, the user may close the multimedia application of the second terminal using a smart terminal, the user may later turn on the first terminal in a different location using the same smart terminal. The first terminal, the second terminal, and the smart terminal may be bound together. The first terminal may obtain the play record information on the second terminal using the identification of the smart terminal. The play record information may be stored at least partially in the smart terminal. The play record information may also be stored in a server. The smart terminal may be a smart remote or an wearable device, which includes a non-transitory memory storage and a chip.

Alternatively or additionally, before the first terminal sends to the server the request for acquiring play record information, the first terminal may output play triggering information for triggering the play of the target multimedia data and send to the server the request for acquiring play record information in response to detection of a triggering operation on the play triggering information.

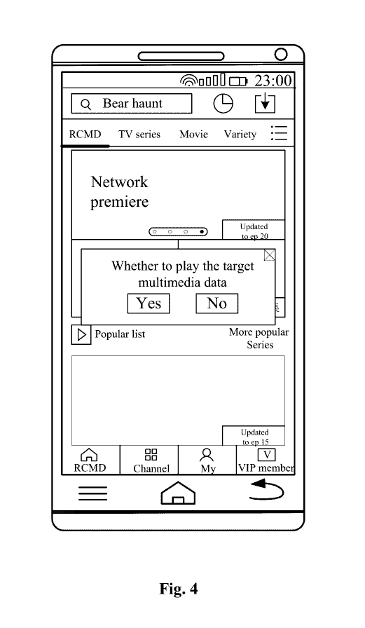

For example, as shown in FIG. 4, when the first terminal detects the start of the multimedia application, the first terminal may display, in an interface, a dialog box for the play triggering information for the target multimedia data. The dialog box displays a prompt of whether to play the target multimedia data, a “Yes” key and a “No” key. The user may click the “Yes” key, and the first terminal may send to the server the request for acquiring play record information when it detects the click instruction.

Alternatively or additionally, the play record information includes a multimedia data identification and a play progress time point corresponding to the target multimedia data; or the play record information includes a channel identification corresponding to the target multimedia data.

For example, if the user watched certain multimedia data by using the second terminal, the server may acquire a multimedia data identification and a play progress time point corresponding to the target multimedia data. For example, if the user watched the movie “A Chinese Odyssey” to the fiftieth minute by using the second terminal, the server may acquire the multimedia data identification as A Chinese Odyssey and the play progress time point as the fiftieth minute.

Alternatively or additionally, if the user watched multimedia data on a certain channel by using the second terminal, the play record information acquired by the server may be the channel identification corresponding to the played multimedia data. For example, if the user watched CCTV news broadcast live on CCTV-1 by using a smart television, then the channel identification acquired by the server is CCTV-1. If the user used a live video application installed on the terminal to watch a live video, the information acquired by the server may be the channel identification corresponding to the played video. For example, if the user used a live video application to watch a live football game broadcast on CCTV-5, the video play information acquired by the server is CCTV-5.

In Step 302, the request for acquiring play record information sent by the first terminal is acquired.

In an implementation, the server receives the request for acquiring play record information sent by the first terminal, and then may analyze the request to acquire, from it, the terminal identification of the first terminal.

In Step 303, the server acquires play record information of a second terminal bound to the first terminal.

In an implementation, after determining the terminal identification of the first terminal, the server can acquire play record information of a second terminal bound to the first terminal according to the identification of the first terminal.

Alternatively or additionally, the play record information of the second terminal bound to the first terminal may be acquired by: sending, to all terminals hound to the first terminal, notifications of uploading play record information respectively; receiving play record information sent by said all terminals; and acquiring, from the play record information sent by said all terminals, the play record information of the second terminal.

In an implementation, after acquiring the terminal identification of the first terminal, the server may acquire terminal identifications of all terminals bound to the first terminal, and then send, to all terminals bound to the first terminal, notifications of uploading play record information respectively. All the terminals bound to the first terminal, after receiving the notifications of uploading play record information, acquire their respective play record information, and send the play record information to the server. The server, after receiving the play record information sent by all the terminals, may acquire the play record information of the second terminal.

Alternatively or additionally, the second terminal is determined from the all terminals, and the second terminal satisfies at least one of the following conditions of: having the same type as the first terminal, being the last one updating the play record information, having logged in a first account which is the same as or associated with that logged in by the first terminal.

For example, when the server determines the second terminal from all the terminals bound to the first terminal, the second terminal satisfies at least one of the following conditions: the second terminal and the first terminal are bound to the same smart terminal; the second terminal has the same type as the first terminal (e.g., both of them can be used to play a video, or both of them can be used to play a music); among all terminals bound to the first terminal, the second terminal is the last one updating the play record information (for example, among all terminals bound to the first terminal, terminals other than the second terminal updated the play record information on October 10 while the second terminal updated the play record information on October 11); the second terminal has logged in a first account which is the same as that logged in by the first terminal (e.g., the second terminal and the first terminal log in by using the same account) or associated with that logged in by the first terminal (e.g., a binding relationship has been established). Here, the smart terminal may be a smart remote, a wearable device, etc.

Alternatively or additionally, the play record information, which is sent by the second terminal when it closes a multimedia application, is received.

For example, the user closes a multimedia application on the second terminal when the user uses the multimedia application to watch certain multimedia data. A management application installed on the second terminal detects the close of the multimedia application, records an identification of the multimedia data currently played and a play progress time point or records a multimedia channel identification, and sends to the server play record information corresponding to the played multimedia data. The play record information may carry the multimedia data identification corresponding to the multimedia data currently played and the play progress time point or carry the channel identification. After receiving the play record information, the server stores the play record information as the play record information of the second terminal.

In Step 304, the server controls the first terminal to continue play of corresponding target multimedia data according to the play record information.

For example, the play record information acquired by the server includes the multimedia identification and the play progress time point corresponding to the multimedia data currently played. This multimedia data can be used as the target multimedia data, and then the multimedia identification and the play progress time point corresponding to the target multimedia data are sent to the first terminal according to the terminal identification of the first terminal, so that the first terminal can continue the play of the target multimedia data from the play progress time point. If the play record information acquired by the server is the channel identification corresponding to the played multimedia data, this channel identification can be sent to the first terminal so that the first terminal can play the multimedia data on a corresponding channel.

Alternatively or additionally, the target multimedia data includes video data, audio data, or both video data and audio data. The target multimedia data may include game data.

In an implementation, the target multimedia data may be video data (e.g. a TV series, a movie, etc.), or may be audio data (e.g. a music, a broadcast content, etc.).

In Step 305, the first terminal receives the play record information of the second terminal bound to the first terminal, which may be sent by the server directly or indirectly.

For example, the first terminal receives the play record information of the second terminal bound to the first terminal which is sent by the server, and then may analyze the play record information and obtain, from the play record information, the multimedia data identification and the play progress time point or the multimedia channel identification.

In Step 306, the first terminal continues the play of the corresponding target multimedia data according to the play record information.

For example, the first terminal may play the corresponding target multimedia data according to the multimedia data identification and the play progress time point carried by the play record information, or may play the corresponding target multimedia data according to the multimedia channel identification in the play record information.

Alternatively or additionally, the first terminal may control the multimedia application to play the corresponding target multimedia data according to the play record information.

For example, when the multimedia data identification and the play progress time point are obtained after the first terminal analyzes the play record information, the target multimedia data corresponding to the multimedia data identification may be searched for, and then the multimedia application may be controlled to play the target multimedia data from the play progress time point. When the multimedia channel identification is obtained after the first terminal analyzes the play record information, a channel corresponding to the multimedia channel identification may be searched for, and then the multimedia application may be controlled to play the multimedia data being currently played on the channel.

Alternatively or additionally, the first terminal may control the multimedia application to continue the play of the multimedia data from the play progress time point by: acquiring, from the play record information, a multimedia data identification and a play progress time point; and continuing the play of the target multimedia data corresponding to the multimedia data identification from the play progress time point.

For example, after acquiring, from the play record information, the multimedia data identification and the play progress time point, the first terminal may search for corresponding target multimedia data according to the multimedia data identification, and then control the multimedia application to continue the play of the target multimedia data from the play progress time point. For example, the multimedia data identification contained in the play record information is “Painted Skin” and the play progress time point is the fiftieth minute and the twenty-third second, so the multimedia application continues the play of “Painted Skin” from the fiftieth minute and the twenty-third second.

Alternatively or additionally, the first terminal may control the multimedia application to play the target multimedia data corresponding to the multimedia channel identification by: acquiring, from the play record information, a multimedia channel identification; and continuing the play of the target multimedia data corresponding to the multimedia channel identification.

In an implementation, after acquiring the multimedia channel identification from the play record information, the first terminal may search, according to the multimedia channel identification, for multimedia data being currently played as the target multimedia data, and then may control the multimedia application to play the target multimedia data. For example, if the multimedia channel identification contained in the play record information is CCTV-1 and if the multimedia data being currently displayed on CCTV-1 is CCTV news, the multimedia application may play CCTV news.

Embodiments of the disclosure further provide a method for sharing, by a user, multimedia data with other users, which may include: receiving a request for sharing multimedia, the request for sharing multimedia being sent from the first terminal and carrying current play record information of the first terminal and an account identification of a target account; and sending, to a target terminal logging in the target account, the current play record information of the first terminal so that the target terminal continues play of corresponding target multimedia data according to the current play record information of the first terminal.

In an implementation, a multimedia application or a management application may provide the user with a sharing key. The user may click the sharing key to share multimedia data with friends. The embodiment of the disclosure is described by taking an example where a multimedia application provides the user with a sharing key and the shared multimedia data is video data. When the user uses the multimedia application in the first terminal to watch a certain video, a video play interface displays a video play screen and options such as a volume key, a sharing key, etc. If the video needs to be shared with friends, the sharing key may be clicked to trigger the first terminal to acquire the current play record information and display a dialog box for adding a target account. The user may input the account identification (e.g. a mobile phone number, an email address, etc.) of the target account into the dialog box, and click a confirmation key. After receiving the click instruction, the first terminal sends to the server a request for sharing multimedia, the request carrying the current play record information of the first terminal and the account identification of the target account. After receiving the request for sharing a video, the server acquires the account identification of the target account, and then sends, to the target terminal having logged in the target account, the current play record information of the first terminal.

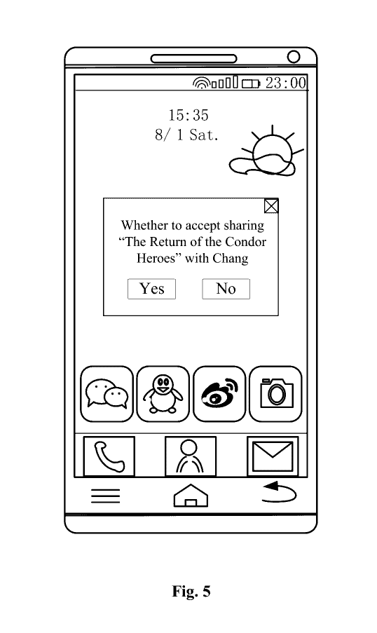

As illustrated in FIG. 5, after the target terminal receives the current play record information of the first terminal, the target terminal displays in an interface whether to accept sharing XXX video data with XXX (for example, whether to accept sharing “The Return of the Condor Heroes” with ZHANG San), if the current play record information, which is obtained by analysis, is a multimedia data identification. If the user of the target terminal accepts the sharing, a “Yes” option may be clicked to trigger the target terminal to display a multimedia application selection dialog box, in which Options for multimedia applications installed on the target terminal are displayed to select from. The user may click an option for a multimedia application to select the multimedia application. After detecting the click instruction, the target terminal starts the multimedia application, searches for the video, and controls the multimedia application to play the video data.

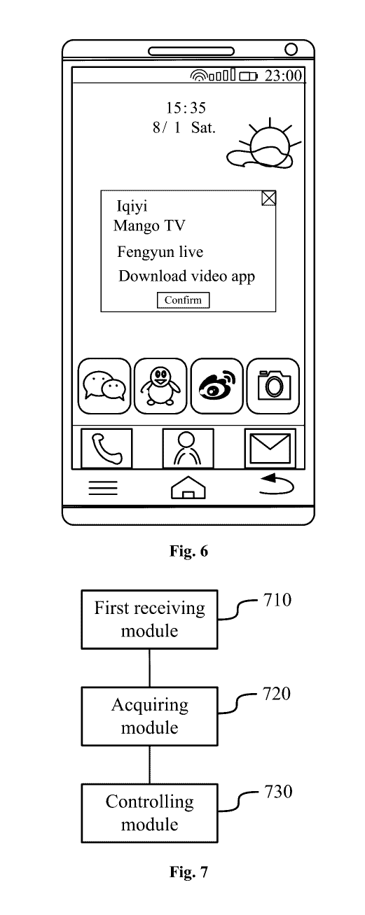

After the target terminal receives the current play record information of the first terminal, the target terminal displays in an interface whether to accept sharing XXX channel with XXX, if the current play record information, which is obtained by an analysis, is a multimedia channel identification. If the user of the target terminal accepts the sharing, a “Yes” option may be clicked to trigger the target terminal to display a multimedia application selection dialog box, in which options for multimedia applications installed on the target terminal (e.g. an Iqiyi option, a Fengyun live option, etc.) are displayed as shown in FIG. 6. The user may click a multimedia application option to select a certain multimedia application, and click a confirmation key. After detecting the click instruction, the target terminal starts the multimedia application, searches for the channel, and controls the multimedia application to play the video data corresponding to the channel.

Furthermore, an option of downloading a multimedia application may further displayed in the multimedia application selection dialog box. If the target terminal has no a multimedia application installed therein or if there is no multimedia application suitable to play video data shared by the first terminal, the multimedia application downloading option may be clicked. Then, the confirmation key is clicked to trigger the entry into a multimedia application downloading interface, so that the user can download a suitable multimedia application.

In the disclosure, a first terminal sends to a server a request for acquiring play record information; the server receives the request for acquiring play record information sent by the first terminal; the server acquires play record information of a second terminal bound to the first terminal; the server controls the first terminal to continue play of corresponding target multimedia data according to the play record information; the first terminal receives the play record information of the second terminal bound to the first terminal, which is sent by the server; and the first terminal continues the play of corresponding target multimedia data according to the play record information. Thereby, when a user changes the terminal during the play of multimedia data, the terminal used after the change may automatically acquire the play record information on the terminal used before the change, and then automatically play the multimedia data corresponding to the play record information. Accordingly, the user can watch the multimedia data be or she previously watched on the terminal used before the change without searching and finding, thereby improving the efficiency in starting the play of the multimedia data.

Another embodiment of the disclosure further provides an apparatus, which may be applied in a server, for playing multimedia data. As illustrated in FIG. 7, the apparatus includes: a first receiving module 710, an acquiring module 720, and a controlling module 730.

The first receiving module 710 is configured to receive a request for acquiring play record information, the request being sent by a first terminal.

The acquiring module 720 is configured to acquire play record information of a second terminal bound to the first terminal.

The controlling module 730 is configured to control the first terminal to continue play of corresponding target multimedia data according to the play record information.

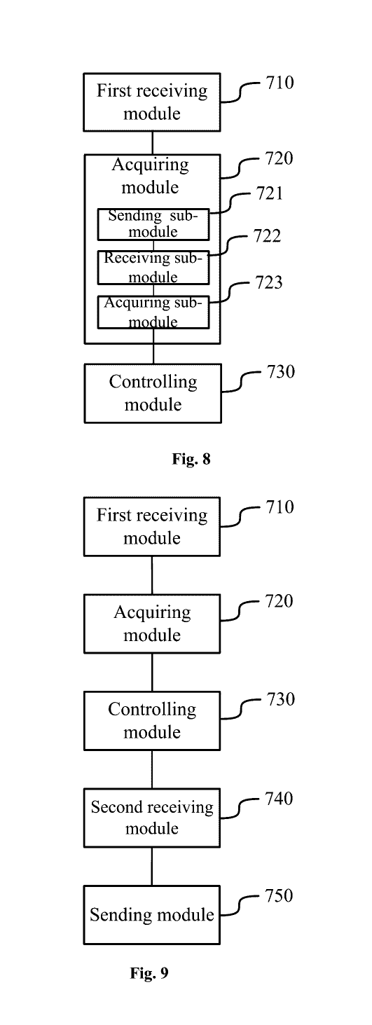

Alternatively or additionally, as illustrated in FIG. 8, the acquiring module 720 comprises a sending sub-module 721, a receiving sub-module 722 and an acquiring sub-module 723.

The sending sub-module 721 is configured to send, to all terminals bound to the first terminal, notifications of uploading play record information respectively.

The receiving sub-module 722 is configured to receive play record information sent by said all terminals.

The acquiring sub-module 723 is configured to acquire, from the play record information sent by said all terminals, the play record information of the second terminal.

Alternatively or additionally, the acquiring sub-module 723 is configured to determine the second terminal from the all terminals, the second terminal satisfying at least one of the following conditions of having the same type as the first terminal, being the last one updating the play record information, having logged in a first account which is the same as or associated with that logged in by the first terminal.

Alternatively or additionally, the acquiring module 720 is configured to: receive the play record information, which is sent by the second terminal when it closes a multimedia application.

Alternatively or additionally, as illustrated in FIG. 9, the apparatus for playing multimedia data further includes: a second receiving module 740 for receiving a request for sharing multimedia, the sharing request for multimedia being sent from the first terminal and carrying current play record information of the first terminal and an account identification of a target account; and a sending module 750 for sending, to a target terminal having logged in the target account, the current play record information of the first terminal so that the target terminal continues play of corresponding multimedia data according to the current play record information of the first terminal.

Alternatively or additionally, the target multimedia data includes: video data or audio data.

Alternatively or additionally, the play record information includes a multimedia data. identification and a play progress time point corresponding to the target multimedia data; or the play record information includes a channel identification corresponding to the target multimedia data.

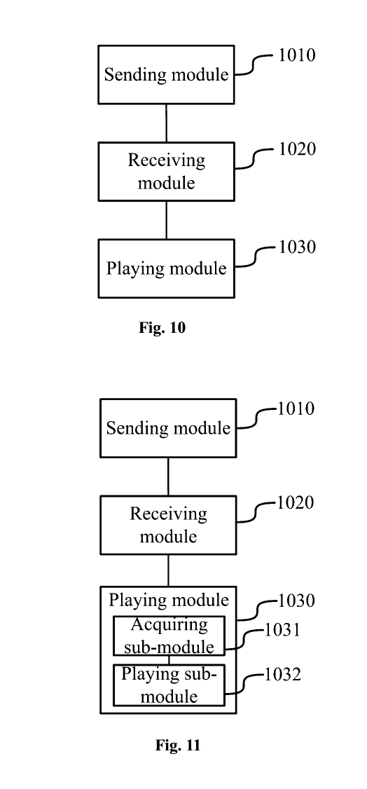

Based on the same technical concept, an embodiment of the disclosure provides an apparatus, which can be applied in the first terminal, for playing multimedia data. As illustrated in FIG. 10, the apparatus includes: a sending module 1010, a receiving module 1020, and a playing module 1030.

The sending module 1010 is configured to send to a server a request for acquiring play record information.

The receiving module 1020 is configured to receive play record information of a second terminal hound to the first terminal, which is sent by the server.

The playing module 1030 is configured to continue play of corresponding target multimedia data according to the play record information,

Alternatively or additionally, the sending module 1010 is configured to: send to the server the request for acquiring play record information when a start of a multimedia application is detected. The playing module 1030 is configured to: control the multimedia application to play the corresponding target multimedia data according to the play record information.

Alternatively or additionally, as illustrated in FIG. 11, the playing module 1030 includes an acquiring sub-module 1031 and a playing sub-module 1032. The acquiring sub-module 1031 is configured to acquire, from the play record information, a multimedia data identification and a play progress time point. The playing sub-module 1032 is configured to continue the play of the target multimedia data corresponding to the multimedia data identification from the play progress time point.

Alternatively or additionally, the acquiring sub-module 1031 is configured to acquire, from the play record information, a multimedia channel identification. The playing sub-module 1032 is configured to continue the play of the target multimedia data corresponding to the multimedia channel identification.

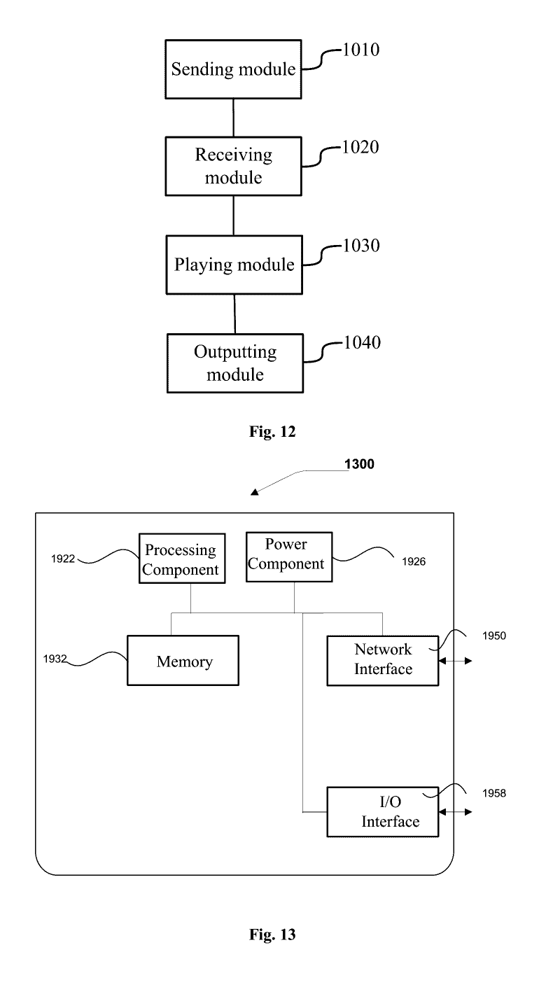

Alternatively or additionally, as illustrated in FIG. 12, the apparatus for playing multimedia data further includes: an outputting module 1040 for, before the request for acquiring play record information is sent to the server, outputting play triggering information for triggering the play of the target multimedia data. The sending module 1010 is configured to: send to the server the request for acquiring play record information, in response to detection of a triggering operation on the play triggering information.

In the disclosure, a first terminal sends to a server a request for acquiring play record information; the server receives the request for acquiring play record information sent by the first terminal; the server acquires play record information of a second terminal bound to the first terminal; the server controls the first terminal to continue play of corresponding target multimedia data according to the play record information; the first terminal receives the play record information of the second terminal bound to the first terminal, which is sent by the server; and the first terminal continues the play of corresponding target multimedia data according to the play record information. Thereby, when a user changes the terminal during the play of multimedia data, the terminal used after the change may automatically acquire the play record information on the terminal used before the change, and then automatically play the multimedia data corresponding to the play record information. Accordingly, the user can watch the multimedia data be or she previously watched on the terminal used before the change without searching and finding, thereby improving the efficiency in starting the play of the multimedia data.

With respect to the apparatus in the above embodiments, the way by which modules perform operations have been described in detail in the related method embodiments, and thus will be omitted here.

It should be noted that the apparatus for displaying multimedia data provided by the above embodiments are described by taking the above division into various functional modules as an example. In practical application, the above functions can be accomplished by different functional modules as needed. That is, the internal structure of apparatus can be divided into different functional modules to implement all or part functions described above. In addition, the methods for playing multimedia data according to the above embodiments and the embodiments of the apparatus for playing multimedia data belong to the same concept. For detailed implementations of the apparatus, reference can be made to the corresponding method embodiments and the description thereof is omitted here.

Another exemplary embodiment of the disclosure provides a system for playing multimedia data. The system includes a server and a first terminal.

The server is configured to receive a request for acquiring play record information, the request being sent by the first terminal; acquire play record information of a second terminal bound to the first terminal; control the first terminal to continue play of corresponding target multimedia data according to the play record information.

The first terminal is configured to send to the server the request for acquiring play record information; receive the play record information of the second terminal bound to the first terminal; and continue the play of the corresponding target multimedia data according to the play record information. Here, the record information may be sent by the server.

In the disclosure, a first terminal sends to a server a request for acquiring play record information. The server receives the request for acquiring play record information sent by the first terminal. The server acquires play record information of a second terminal bound to the first terminal. The server controls the first terminal to continue play of corresponding target multimedia data according to the play record information. The first terminal receives the play record information of the second terminal bound to the first terminal, which is sent by the server. The first terminal continues the play of corresponding target multimedia data according to the play record information. Thereby, when a user switches from a second terminal to a first terminal during the play of multimedia data, the first terminal may automatically acquire the play record information on the second terminal, and then automatically play the multimedia data corresponding to the play record information. Accordingly, the user can watch the multimedia data be or she previously watched on the second terminal used before the change without searching and finding, thereby improving the efficiency in starting the play of the multimedia data.

Another exemplary embodiment of the disclosure provides a server. Referring to FIG. 13, the server 1300 comprises: a processing component 1922, which further includes one or more processors; and storage resources represented by a memory 1932, for storing instructions, i.e., applications, executable by the processing component 1922, The applications stored in the memory 1932 may include one or more modules each corresponding to a set of instructions. Further, the processing component 1922 is configured to execute instructions to perform the above method for play multimedia data.

The server 1300 can further include: a power component 1926 configured to perform power management for the server 1300, a wired or wireless network interface 1950 configured to connect the server 1300 to a network, and an input/output (10) interface 1958. The server 1300 can operate based on an operating system stored in the memory 1932, e.g., Windows Server™, MAC OS X™, Unix™, Linux™, FreeBSD™, or the like.

The memory of the server 1300 may store one or more programs. The one or more processors are configured to execute instructions contained in the one or more programs to: receive a request for acquiring play record information, the request being sent by a first terminal; acquire play record information of a second terminal bound to the first terminal; and control the first terminal to continue play of corresponding target multimedia data according to the play record information.

Alternatively or additionally, the acquiring the play record information of the second terminal bound to the first terminal includes: sending, to all terminals bound to the first terminal, notifications of uploading play record information respectively; receiving play record information sent by said all terminals; acquiring, from the play record information sent by said all terminals, the play record information of the second terminal.

Alternatively or additionally, the acquiring, from the play record information sent by said all terminals, the play record information of the second terminal includes determining the second terminal from the all terminals, the second terminal satisfying at least one of the following conditions of: having the same type as the first terminal, being the last one updating the play record information, having logged in a first account which is the same as or associated with that logged in by the first terminal.

Alternatively or additionally, the acquiring the play record information of the second terminal bound to the first terminal includes: receiving the play record information, which is sent by the second terminal when it closes a multimedia application.

Alternatively or additionally, the method for playing multimedia data further includes: receiving a request for sharing multimedia, the request for sharing multimedia being sent from the first terminal and carrying current play record information of the first terminal and an account identification of a target account; and sending, to a target terminal having logged in the target account, the current play record information of the first terminal so that the target terminal continues play of corresponding target multimedia data according to the current play record information of the first terminal.

Alternatively or additionally, the target multimedia data includes: video data or audio data.

Alternatively or additionally, the play record information includes a multimedia data identification and a play progress time point corresponding to the target multimedia data; or the play record information includes a channel identification corresponding to the target multimedia data.

In the disclosure, a first terminal sends to a server a request for acquiring play record information; the server receives the request for acquiring play record information sent by the first terminal; the server acquires play record information of a second terminal bound to the first terminal; the server controls the first terminal to continue play of corresponding target multimedia data according to the play record information; the first terminal receives the play record information of the second terminal bound to the first terminal, which is sent by the server; and the first terminal continues the play of corresponding target multimedia data according to the play record information. Thereby, when a user changes the terminal during the play of multimedia data, the terminal used after the change may automatically acquire the play record information on the terminal used before the change, and then automatically play the multimedia data corresponding to the play record information. Accordingly, the user can watch the multimedia data be or she previously watched on the terminal used before the change without searching and finding, thereby improving the efficiency in starting the play of the multimedia data.

Another exemplary embodiment of the disclosure provides a terminal, which may be a handset, a tablet computer or the like.

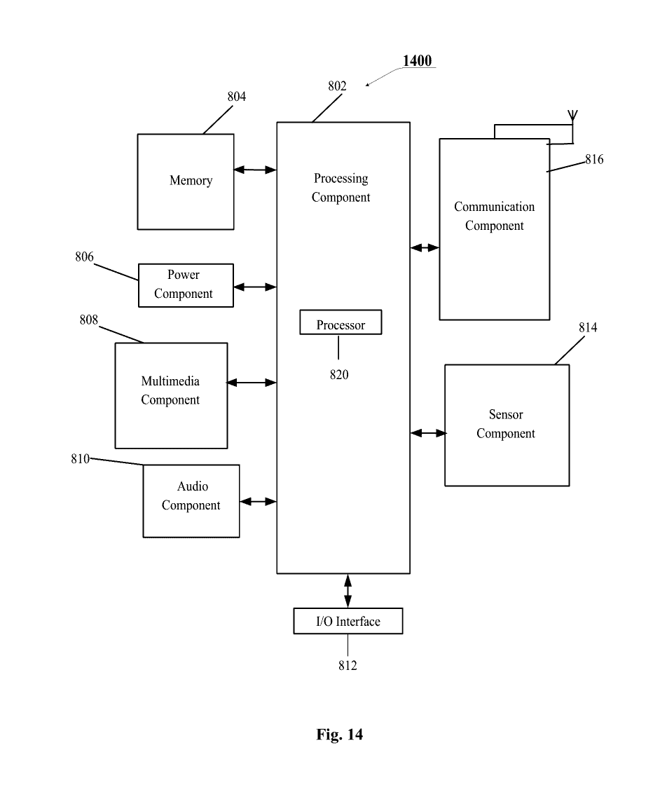

Referring to FIG. 14, the terminal 1400 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls the overall operations of the terminal 1400, for example, display, phone call, data communication, camera operation and record operation. The processing component 802 may include one or more processors 820 to execute instructions to perform all or part of the steps in the above described methods. In addition, the processing component 802 may include one or more modules to facilitate the interaction between the processing component 802 and other components. For example, the processing component 802 may include a multimedia module to facilitate the interaction between the processing component 808 and the processing component 802.

The memory 804 is configured to store various types of data to support the operation performed on the terminal 1400. Examples of such data include instructions for any applications or methods operated on the terminal 1400, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal 1400. The power component 806 may include a power supply management system, one or more power sources, and any other components associated with the generation, management, and distribution of power in the terminal 1400.

The multimedia component 808 includes a screen providing an output interface between the terminal 1400 and the user. In some embodiments, the screen may include a Liquid Crystal Display (LCD) and a Touch Panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action, in some embodiments, the multimedia component 808 includes a front camera and/or a rear camera. The front camera and the rear camera may receive external multimedia data while the terminal 1400 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the terminal 1400 is in an operation mode, such as a call mode, a recording mode, and a voice recognition mode. The received audio signal may be further stored in the memory 804 or transmitted via the communication component 816.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal 1400. For instance, the sensor component 814 may detect an open/closed. status of the terminal 1400, relative positioning of components, e.g., the display and the keypad, of the terminal 1400, a change in position of the terminal 1400 or a component of the terminal 1400, a presence or absence of user contact with the terminal 1400, an orientation or an acceleration/deceleration of the terminal 1400, and a change in temperature of the terminal 1400. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, a microwave sensor or a temperature sensor.

The communication component 816 is configured to facilitate wired or wireless communication between the terminal 1400 and other devices. The terminal 1400 can access a wireless network based on a communication standard, such as WiFi, 2G, or 3G, or a combination thereof. In one exemplary embodiment, the communication component 816 receives a broadcast signal or broadcast related information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal 1400 may be implemented with one or more circuitries, which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The apparatus may use the circuitries in combination with the other hardware or software components for performing the above described methods. Each module, sub-module, unit, or sub-unit in the disclosure may be implemented at least partially using the one or more circuitries.

In exemplary embodiments, there is also provided a non-transitory computer-readable storage medium including instructions, such as included in the memory 804, executable by the processor 820 of the terminal 1400, for performing the above-described methods. For example, the non-transitory computer-readable storage medium may be a ROM, a RAM, a CD-ROM, a magnetic tape, a floppy disc, an optical data storage device, and the like.

When executed by the processor of a terminal, the instructions in the non-transitory computer-readable storage medium cause the terminal to perform the above method, which comprises: sending to a server a request for acquiring play record information; receiving play record information of a second terminal bound to the first terminal, which is sent by the server; and continuing play of corresponding target multimedia data according to the play record information.

Alternatively or additionally, the sending to the server the request for acquiring play record information comprises: sending to the server the request for acquiring play record information when a start of a multimedia application is detected. The continuing the play of the corresponding target multimedia data according to the play record information comprises: controlling the multimedia application to play the corresponding target multimedia data according to the play record information.

Alternatively or additionally, the continuing the play of the corresponding target multimedia data according to the play record information comprises: acquiring, from the play record information, a multimedia data identification and a play progress time point; and continuing the play of the target multimedia data corresponding to the multimedia data identification from the play progress time point.

Alternatively or additionally, the continuing the play of the corresponding target multimedia data according to the play record information comprises: acquiring, from the play record information, a multimedia channel identification; and continuing the play of the target multimedia data corresponding to the multimedia channel identification.

Alternatively or additionally, before sending to the server the request for acquiring the play record information, the method further comprises: outputting play triggering information for triggering the play of the target multimedia data. The sending to the server the request for acquiring play record information comprises: sending to the server the request for acquiring play record information, in response to detection of a triggering operation on the play triggering information.

In the disclosure, a first terminal sends to a server a request for acquiring play record information; the server receives the request for acquiring play record information sent by the first terminal; the server acquires play record information of a second terminal bound to the first terminal; the server controls the first terminal to continue play of corresponding target multimedia data according to the play record information; the first terminal receives the play record information of the second terminal bound to the first terminal, which is sent by the server; and the first terminal continues the play of corresponding target multimedia data according to the play record information. Thereby, when a user changes the terminal during the play of multimedia data, the terminal used after the change may automatically acquire the play record information on the terminal used before the change, and then automatically play the multimedia data corresponding to the play record information. Accordingly, the user can watch the multimedia data be or she previously watched on the terminal used before the change without searching and finding, thereby improving the efficiency in starting the play of the multimedia data.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the appended claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A method for playing multimedia data, comprising:
receiving a request for acquiring play record information, the request being sent by a first terminal;
acquiring play record information of a second terminal bound to the first terminal; and
controlling the first terminal to continue play of corresponding target multimedia data according to the play record information.

2. The method of claim 1, wherein acquiring the play record information of the second terminal bound to the first terminal comprises:
sending, to all terminals bound to the first terminal, notifications of uploading play record information respectively;
receiving play record information sent by all terminals; and
acquiring, from the play record information sent by all terminals, the play record information of the second terminal.

3. The method of claim 2, wherein acquiring, from the play record information sent by all terminals, the play record information of the second terminal comprises:
determining the second terminal from all terminals, the second terminal satisfying at least one of the following conditions of: having the same type as the first terminal, being the last one updating the play record information, and having logged in a first account that is the same as or associated with that logged in by the first terminal.

4. The method of claim 1, wherein acquiring the play record information of the second terminal bound to the first terminal comprises:
receiving the play record information, which is sent by the second terminal when it closes a multimedia application.

5. The method of claim 1, further comprising:
receiving a request for sharing multimedia, the request for sharing multimedia being sent from the first terminal and carrying current play record information of the first terminal and an account identification of a target account; and
sending, to a target terminal having logged in the target account, the current play record information of the first terminal so that the target terminal continues play of corresponding target multimedia data according to the current play record information of the first terminal.

6. The method of claim 1, wherein the target multimedia data comprises at least one of: video data and audio data.

7. The method of claim 1, wherein the play record information comprises a multimedia data identification and a play progress time point corresponding to the target multimedia data; or the play record information comprises a channel identification corresponding to the target multimedia data.

8. An apparatus for playing multimedia data, comprising: a processor and a memory storing instructions executable by the processor, wherein the processor is configured to:
receive a request for acquiring play record information, the request being sent by a first terminal;
acquire play record information of a second terminal bound to the first terminal; and
control the first terminal to continue play of corresponding target multimedia data according to the play record information.

9. The apparatus of claim 8, wherein the processor is further configured to:
send, to all terminals bound to the first terminal, notifications of uploading play record information respectively;
receive play record information sent by all terminals; and
acquire, from the play record information sent by all terminals, the play record information of the second terminal.

10. The apparatus of claim 9, wherein the processor is further configured to:
determine the second terminal from all terminals, the second terminal satisfying at least one of the following conditions of: having the same type as the first terminal, being the last one updating the play record information, and having logged in a first account that is the same as or associated with that logged in by the first terminal.

11. The apparatus of claim 8, wherein the processor is further configured to:
receive the play record information, which is sent by the second terminal when it closes a multimedia application.

12. The apparatus of claim 8, wherein the processor is further configured to:
receive a request for sharing multimedia, the request for sharing multimedia being sent from the first terminal and carrying current play record information of the first terminal and an account identification of a target account; and
send, to a target terminal having logged in the target account, the current play record information of the first terminal so that the target terminal continues play of corresponding target multimedia data according to the current play record information of the first terminal.

13. The apparatus of claim 8, wherein the target multimedia data comprises video data or audio data.

14. The apparatus of claim 8, wherein the play record information comprises a multimedia data identification and a play progress time point corresponding to the target multimedia data.

15. The apparatus of claim 8, wherein the play record information comprises a channel identification corresponding to the target multimedia data.

16. A non-transitory computer-readable storage medium having stored therein instructions that, when executed by a processor of a mobile terminal, causes the mobile terminal to perform acts comprising:
receiving a request for acquiring play record information, the request being sent by a first terminal;
acquiring play record information of a second terminal bound to the first terminal; and
controlling the first terminal to continue play of corresponding target multimedia data according to the play record information

17. The storage medium of claim 16, wherein the acquiring the play record information of the second terminal bound to the first terminal comprises:
sending, to all terminals bound to the first terminal, notifications of uploading play record information respectively;
receiving play record information sent by all terminals; and
acquiring, from the play record information sent by all terminals, the play record information of the second terminal.

18. The storage medium of claim 17, wherein the acquiring, from the play record information sent by all terminals, the play record information of the second terminal comprises:
determining the second terminal from all terminals, the second terminal satisfying at least one of the following conditions of: having the same type as the first terminal, being the last one updating the play record information, and having logged in a first account that is the same as or associated with that logged in by the first terminal.

19. The storage medium of claim 16, wherein the acquiring the play record information of the second terminal bound to the first terminal comprises:
receiving the play record information, which is sent by the second terminal when it closes a multimedia application.

20. The storage medium of claim 16, wherein the method further comprises: receiving a request for sharing multimedia, the request for sharing multimedia being sent from the first terminal and carrying current play record information of the first terminal and an account identification of a target account; and
sending, to a target terminal having logged in the target account, the current play record information of the first terminal so that the target terminal continues play of corresponding target multimedia data according to the current play record information of the first terminal.
